(19) United States
(12) Patent Application Publication
(10) Pub. No.: US 2026/0312475 A1
(43) Pub. Date: Oct. 8, 2026

(54) Electric Machine, Electric Axle Drive, Motor Vehicle, And Method For Manufacturing An Electric Machine

(71) Applicant: ZF FRIEDRICHSHAFEN AG, Friedrichshafen (DE)

(72) Inventor: Robin MICHELBERGER, Schweinfurt (DE)

(73) Assignee: ZF FRIEDRICHSHAFEN AG, Friedrichshafen (DE)

(21) Appl. No.: 19/472,490

(22) PCT Filed: Apr. 11, 2024
(86) PCT No.: PCT/EP2024/059778

§ 371 Date: Oct. 3, 2025

(30) Foreign Application Priority Data
Apr. 14, 2023 (DE) 10 2023 203 385.2

(51) Int. Cl. H02K 19/12; H02K 15/026

(52) U.S. Cl. CPC H02K 19/12; H02K 15/026

(57) ABSTRACT

An electric machine (100) has a rotor ferrite core (105) and a stator ferrite core (110). The rotor ferrite core (105) has a long rotor portion (155) and a short rotor portion (165), and the rotor ferrite core (105) has an L-shaped cross section. The stator ferrite core (110) has a long stator portion (160) and a short stator portion (170), and the stator ferrite core (110) has an L-shaped cross section. The rotor ferrite core (105) and the stator ferrite core (110) are arranged adjacent one another.

### PRIORITY CLAIM

This is a U.S. national stage of application No. PCT/EP2024/059778, filed on 11 Apr. 2024. Priority is claimed on German, Application No. 10 2023 203 385.2, filed 14 Apr. 2023, the content of which is incorporated herein by reference.

### BACKGROUND OF THE INVENTION

The present invention is directed to an electric machine, an electric axle drive, a motor vehicle, and a method for producing an electric machine.

Inductive exciter units comprising two radially arranged cores are known.

Against this background, the present invention provides an improved electric machine, an improved electric axle drive, an improved motor vehicle and an improved method for producing an electric machine in accordance with the main claims. Advantageous embodiments will be apparent from the subclaims and the following description.

The advantages achievable with the approach proposed herein consist in particular in that an electric machine is provided that can enable a high power density.

### SUMMARY OF THE INVENTION

An electric machine has a rotor ferrite core and a stator ferrite core. The rotor ferrite core has a long rotor portion and a short rotor portion, with the rotor ferrite core having an L-shaped cross section. The stator ferrite core has a long stator portion and a short stator portion, with the stator ferrite core having an L-shaped cross section. The rotor ferrite core and the stator ferrite core are arranged adjacent one another.

The electric machine may be, for example, a separately excited synchronous machine which can drive a motor vehicle, for example. The rotor ferrite core and the stator ferrite core may be parts of a coil and may be constructed, for example, as soft magnetic ferrites. The rotor ferrite core may be rotatable and the stator ferrite core may be fixed with respect to relative rotation. The rotor ferrite core and the stator ferrite core can be pressed into the desired shape by means of a pressing process. The approach proposed herein may also be seen as an inductive exciter device with high power density and can make possible an inductive exciter unit for the contactless transmission of electrical power from a stationary part to a rotating part in an electric machine. The installation space of the electric machine can be advantageously implemented. In other words, the approach proposed herein can enable a high power density without requiring additional installation space.

The long stator portion can be formed thicker than the long rotor portion. In addition or alternatively, the short rotor portion can be formed thicker than the short stator portion. The long stator portion and the short stator portion can be formed in one piece. The long rotor portion and the short rotor portion can also be formed in one piece.

The long rotor portion can have a smaller thickness than the short rotor portion. In this way, radial and/or axial installation space can be economized in an advantageous manner.

The long stator portion can have a smaller thickness than the short stator portion. In this way, radial and/or axial installation space can be economized in an advantageous manner.

A first air gap between the short rotor portion and the long stator portion can be smaller than an air gap between the long rotor portion and the long stator portion. In addition or alternatively, a second air gap between the long rotor portion and the short rotor portion can be smaller than the air gap between the long rotor portion and the long stator portion. The first air gap and/or the second air gap can increase a magnetic resistance in the magnetic circuit.

The stator ferrite core can be arranged adjacent to a rotational axis of a rotor. In addition or alternatively, the long stator portion can be arranged or arrangeable between the rotor ferrite core and the rotational axis. In this way, radial and/or axial installation space can be economized in an advantageous manner.

The long stator portion and, additionally or alternatively, the long rotor portion can be arranged or arrangeable substantially parallel to the rotational axis. Installation space can advantageously be saved in this way.

The stator ferrite core and the rotor ferrite core can be arranged or arrangeable axially relative to one another. Installation space can advantageously be saved in this way.

The electric machine can have windings. The windings can be arranged or arrangeable at the rotor ferrite core and additionally or alternatively at the stator ferrite core. A rotor coil and/or a stator coil can advantageously be formed in this way.

The windings can be formed as litz wire, in particular as high-frequency litz wire. The litz wire can comprise thin individual wires. High-frequency litz wire can reduce or prevent a skin effect, also known as a current displacement effect.

In addition, the invention is directed to an electric axle drive for a motor vehicle with at least one embodiment form of an electric machine described herein and a transmission device. By using the transmission device, a torque provided by the electric machine can be converted into a drive torque for driving at least one wheel of a motor vehicle. The transmission device can comprise a gearbox for reducing the speed of the electric machine and, optionally, a differential.

In addition, the invention is directed to a motor vehicle with an embodiment form of an electric machine mentioned herein and, additionally or alternatively, with an embodiment form of an electric axle drive mentioned herein. The motor vehicle can be constructed as an electrically operated motor vehicle.

A method for producing an embodiment form of an electric machine mentioned herein comprises a step of arranging the rotor ferrite core and the stator ferrite core. The step of arranging is executed in such a way that the rotor ferrite core and the stator ferrite core are arranged adjacent one another. Optionally, the method can include a step of attaching the windings to the rotor ferrite core and/or the stator ferrite core.

The approach proposed herein further provides an apparatus which is formed to carry out, actuate or implement the step of a variant of a method proposed herein in a corresponding device. The object upon which the invention is based can also be met quickly and efficiently by means of this embodiment variant of the invention in the form of an apparatus.

An apparatus may be an electrical device that processes electrical signals, for example, sensor signals, and outputs control signals depending thereon. The apparatus can have one or more suitable interfaces which can be formed as hardware and/or software. When implemented as hardware, the interfaces can be part of an integrated circuit, for example, in which the functions of the apparatus are implemented. The interfaces can also be separate integrated circuits or at least partially comprise discrete components. If implemented as software, the interfaces can be software modules that are provided in addition to other software modules, for example, on a microcontroller.

### BRIEF DESCRIPTION OF THE DRAWINGS

The invention is described in more detail by way of example with reference to the accompanying drawings. The drawings show:

FIG. 1a a schematic partial sectional view of an exemplary embodiment of an electric machine;

FIG. 1b a schematic partial sectional view of an exemplary embodiment of an electric machine;

FIG. 2 a diagram illustrating an exemplary embodiment of an electric machine;

FIG. 3 a flowchart of an exemplary embodiment of a method for producing an electric machine;

FIG. 4 a block diagram of an exemplary embodiment of an apparatus for producing an electric machine; and

FIG. 5 a schematic representation of an exemplary embodiment of a motor vehicle.

### DETAILED DESCRIPTION OF THE DISCLOSED EMBODIMENTS

In the following description of preferred exemplary embodiments of the present invention, the same or similar reference numerals are used for elements shown in the various figures and having similar functions so as to avoid repetitive description of these elements.

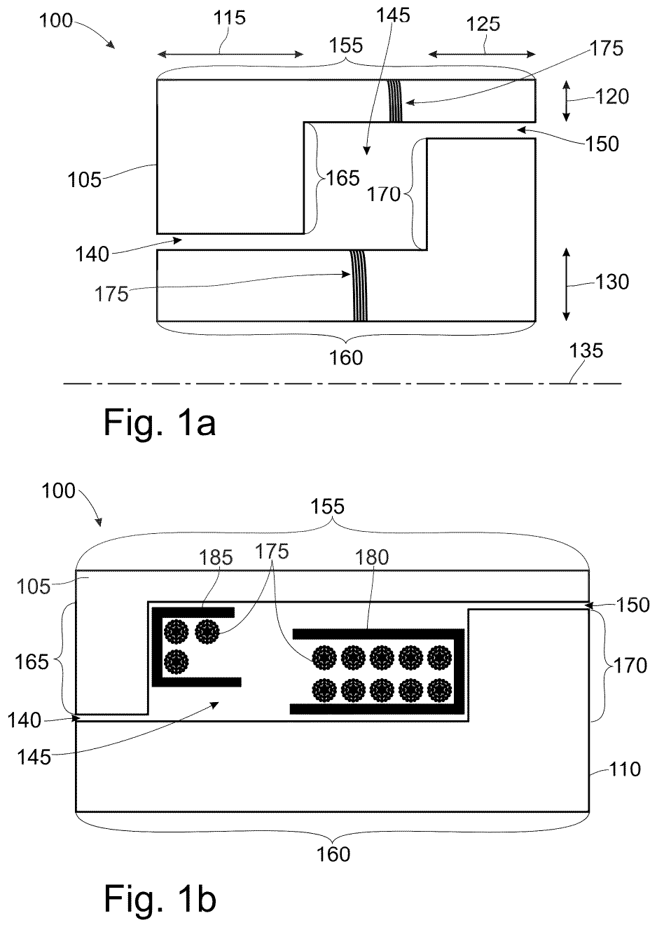

FIGS. 1a-b show a schematic partial sectional view of an exemplary embodiment of an electric machine 100. The electric machine 100 is constructed, for example, as a separately excited synchronous machine which can drive, for example, a motor vehicle, more precisely an electrically operated motor vehicle.

The electric machine 100 has a rotor ferrite core 105 and a stator ferrite core 110, and the ferrite cores 105, 110 are arranged adjacent one another, for example, axial to one another. According to an exemplary embodiment, a rotational axis 135 of a rotor is shown, and the stator ferrite core 110 is arranged, for example, adjacent the rotational axis 135 of the rotor.

The rotor ferrite core 105 and the stator ferrite core 110 have in each instance an L-shaped cross section. The rotor ferrite core 105 has a long rotor portion 155 and a short rotor portion 165, and the short rotor portion 165 is arranged radially at the long rotor portion 155, resulting in the L-shaped cross section. The same is true for the stator ferrite core 110 which has a long stator portion 160 and a short stator portion 170. The short stator portion 170 is arranged radially at the long stator portion 160. This also results in the L-shaped cross section for the stator ferrite core 110.

According to an exemplary embodiment, a thickness 120 of the long rotor portion 155 is formed to be smaller than a thickness 130 of the long stator portion 160, and a thickness 125 of the short stator portion 170 is formed to be smaller than a thickness 115 of the short rotor portion 165. The thicknesses 115, 120, 125, 130 are shown by way of example by means of double arrows.

In the exemplary embodiment shown here, for example, the long stator portion 160 is arranged between the rotor ferrite core 105 and the rotational axis 135. The long stator portion 160 and/or the long rotor portion 155 are/is arranged substantially parallel to the rotational axis 135.

More precisely, the rotor ferrite core 105 and the stator ferrite core 110 are arranged relative to one another such that the short rotor portion 165 and the short stator portion 170 are arranged between the long rotor portion 155 and the long stator portion 160. A first air gap 140 is arranged between the short rotor portion 165 and the long stator portion 160. In addition, a second air gap is arranged between the long rotor portion 155 and the short stator portion 170. Further, an air gap 145 is arranged between the long rotor portion 155 and the long stator portion 160. The air gap 145 is arranged between the first air gap 140 and the second air gap 150.

According to an exemplary embodiment, the first air gap 140 and the second air gap 150 have a substantially identical thickness and/or are smaller than air gap 145. Air gap 145 has a square shape, for example.

According to an exemplary embodiment, windings 175 are arranged at the rotor ferrite core 105 and the stator ferrite core 110. More exactly, the windings 175 are arranged merely by way of example at the long rotor portion 155 and the long stator portion 160. Alternatively, the windings 175 are arrangeable at the short rotor portion 165 and the short stator portion 170. The windings 175 are formed, for example, as litz wire, in particular as high-frequency litz wire.

In other words, FIG. 1 shows a schematic diagram of the rotor ferrite core 105 and the stator ferrite core 110, which may also be referred to as cores. The approach proposed herein represents a combination of rotor ferrite core 105 and stator ferrite core 110, which may also be referred to as ferrite, the windings 175, which may also be referred to as high-frequency litz wire, or HF litz wire for short, and an axial arrangement of the rotor ferrite core 105 and the stator ferrite core 110.

The approach proposed herein allows high feed frequencies of 100 to 150 kilohertz to be used. Ferrites are used as core material for the rotor ferrite core 105 and the stator ferrite core 110 to ensure efficient flux guidance. By using high-frequency litz wire for the windings 175, the so-called current displacement effect or skin effect which reduces the increase in resistance, is reduced or prevented. In this way, the winding window can be made smaller compared to flat ribbon cable, so that the electric machine 100, which may also be referred to as exciter unit, can be made more compact overall. The axial arrangement of the rotor ferrite core 105 and stator ferrite core 110, which may also be referred to as the primary coil and secondary coil, saves radial installation space. Further, the rotor ferrite core 105 and the stator ferrite core 110 have appreciably different thicknesses 115, 120, 125, 130 of the individual portions 155, 160, 165, 170, which may also be referred to as parts, through which the magnetic field passes.

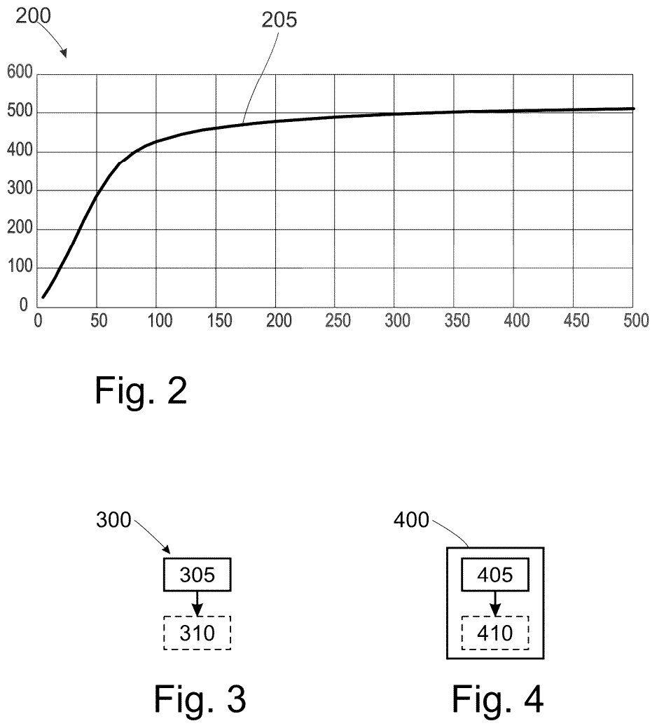

FIG. 2 shows a diagram 200 illustrating an exemplary embodiment of an electric machine. The diagram 200 shows a curve 205 of a magnetic flux density B versus magnetic field strength H, in other words, a typical B-H curve. A magnetic field strength H in amperes per meter is plotted on the abscissa and a magnetic flux density B in millitesla is plotted on the ordinate.

A magnetic field strength H is brought about in the cores by the coils located in the interior of the cores. This is linked to the magnetic flux density B via material characteristics. For efficient operation, the saturation range should be avoided and the flux density B should be distributed homogeneously across the cores. Since the volume of the stator yoke is appreciably smaller, with the thickness of a rotor yoke and stator yoke being identical, the difference must be compensated by increasing the thickness of the long stator portion, which may also be designated by “b”. The air gap between the rotor and stator leads to an increase in the magnetic resistance Rₘ compared to the ferromagnetic parts. Rₘ=I/(μ₀*μᵣ*A, where I=length to be bridged; μ₀ is the magnetic field constant, which may also be referred to as a constant; μᵣ is the permeability number, which may also be referred to as a material-dependent constant; μᵣ (air)=1 μᵣ (ferrite)=x*1000; A=cross section through which flow occurs. In order to minimize scattering at the transition between the cores, Rₘ is kept as small as possible. Length/and constants μ₀, μᵣ are fixed. This can be achieved by increasing the cross-sectional area. Since the thickness of the short stator portion, which may also be designated by “d”, lies on a larger outer diameter, the thickness of the short stator portion can be made smaller than the thickness of the short rotor portion, which may also be designated by “c”. Since the magnetic permeability of ferromagnetic materials such as ferrite or sheet metal is appreciably greater than that of air, both the thickness of the short rotor portion and the thickness of the short stator portion are appreciably greater than the thickness of the long rotor portion, which may also be designated by “a”, or than the thickness of the long stator portion.

FIG. 3 shows a flowchart of an exemplary embodiment of a method 300 for producing an electric machine. The electric machine corresponds to or is similar to the electric machine shown in one of the figures described herein. The method 300 comprises a step 305 of arranging the rotor ferrite core and the stator ferrite core. Step 305 of arranging is carried out in such a way that the rotor ferrite core and the stator ferrite core are arranged adjacent one another. Optionally, method 300 comprises a step 310 of attaching the windings to the stator ferrite core and the rotor ferrite core.

FIG. 4 shows a block diagram of an exemplary embodiment of an apparatus 400 for producing an electric machine. The apparatus 400 is formed to carry out and/or control the method shown in FIG. 3 or a similar method. The apparatus 400 has an arrangement unit 405 that is formed to carry out and/or actuate the step of arranging. Optionally, the apparatus 400 has an attachment unit 410 that is formed to carry out and/or control the step of attaching.

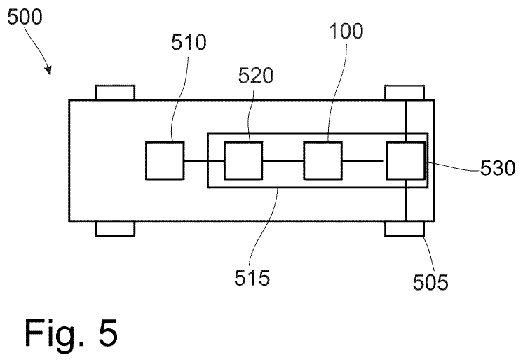

FIG. 5 shows a schematic diagram of an exemplary embodiment of a motor vehicle 500. The motor vehicle 500 is constructed, for example, as an electrically operated motor vehicle. Of the motor vehicle 500, wheels 505, four wheels merely by way of example, an electrical energy storage 510, for example, a battery, and an electric axle drive 515 are shown. The electric axle drive 515 comprises a power converter 520, an electric machine 100 and a transmission device 530. The electric machine is similar to or corresponds to the electric machine shown in one of the figures described herein.

Electrical energy for operating the electric machine 100 is provided by an energy supply device, in this case, the electrical energy storage 510. The electrical energy storage 510 is formed to provide direct current which is converted into alternating current, for example, three-phase alternating current, using a power converter 520 of the electric axle drive 515 and supplied to the electric machine 100. A shaft driven by the electric machine 100 is coupled directly, or using the transmission device 530, to at least one wheel 505 of the motor vehicle 500. Accordingly, the motor vehicle 500 can be propelled using the electric machine 100. According to an exemplary embodiment, the electric axle drive 515 comprises a housing in which the power converter 520, the electric machine 100 and the transmission device 530 are arranged.

The exemplary embodiments described and shown in the figures are selected only by way of example. Different exemplary embodiments can be combined with one another, either in their entirety or with respect to individual features. Further, one exemplary embodiment can be supplemented by features of another exemplary embodiment.

Further, method steps according to the invention can be repeated and carried out in a different order than that described.

When an exemplary embodiment includes an “and/or” conjunction between a first feature and a second feature, this can be read to mean that the exemplary embodiment has both the first feature as well as the second feature according to one embodiment, and has either just the first feature or just the second feature according to another embodiment.

1. An electric machine comprising: a rotor ferrite core with a long rotor portion and a short rotor portion, wherein the rotor ferrite core has an L-shaped cross section; and a stator ferrite core with a long stator portion and a short stator portion, wherein the stator ferrite core has an L-shaped cross section, and wherein the rotor ferrite core and the stator ferrite core are arranged adjacent one another.

2. The electric machine according to claim 1, wherein the long stator portion is formed thicker than the long rotor portion and/or wherein the short rotor portion is formed thicker than the short stator portion.

3. The electric machine according to claim 1, wherein the long rotor portion has a smaller thickness than the short rotor portion.

4. The electric machine according to claim 1, wherein the long stator portion has a smaller thickness than the short stator portion.

5. The electric machine according to claim 1, wherein a first air gap between the short rotor portion and the long stator portion is smaller than an air gap between the long rotor portion and the long stator portion and/or wherein a second air gap between the long rotor portion and the short rotor portion is smaller than the air gap between the long rotor portion and the long stator portion.

6. The electric machine according to claim 1, wherein the stator ferrite core is arranged adjacent to a rotational axis of a rotor and/or wherein the long stator portion is arranged or can be arranged between the rotor ferrite core and the rotational axis.

7. The electric machine according to claim 1, wherein the long stator portion and/or the long rotor portion are arranged or can be arranged substantially parallel to the rotational axis.

8. The electric machine according to claim 1, wherein the stator ferrite core and the rotor ferrite core are arranged or can be arranged axially relative to one another.

9. The electric machine according to claim 1, having windings which are arranged or can be arranged at the rotor ferrite core and/or at the stator ferrite core.

10. The electric machine according to claim 9, wherein the windings are formed as litz wire.

11. An electric axle drive for a motor vehicle with at least one electric machine according to claim 1 and further having a transmission device.

12. A motor vehicle comprising an electric machine according to claim 1.

13. A method for producing an electric machine according to claim 1, comprising: arranging the rotor ferrite core and the stator ferrite core such that the rotor ferrite core and the stator ferrite core are arranged adjacent one another.

14. (canceled)

15. A motor vehicle comprising an electric axle drive according to claim 11.
